(19) United States
(12) Patent Application Publication
(10) Pub. No.: US 2023/0336516 A1
(43) Pub. Date: Oct. 19, 2023

(54) RECOMMENDING CONNECTIONS TO USERS OF A SOCIAL NETWORKING SYSTEM TO MAXIMIZE A UTILITY FUNCTION

(71) Applicant: Meta Platforms, Inc., Menlo Park, CA (US)

(72) Inventors: Jake Bograd-Denton, San Francisco, CA (US); Sourav Chatterji, Fremont, CA (US)

(21) Appl. No.: 15/993,536

(22) Filed: May 30, 2018

(51) Int. Cl. H04L 12/58; G06Q 50/00; G06F 15/18

(52) U.S. Cl. CPC H04L 51/32; G06Q 50/01; G06F 15/18

(57) ABSTRACT

A social networking system sends a recommendation to a target user of the social networking system to follow a subject user of the social networking system by identifying subject users who the target user is not following. For each type of recommendation generator capable of generating a recommendation for the target user to follow a subject user, the social networking system computes a value of a utility function based at least in part on a set of existing connections between the target user and a set of social networking system users, a potential connection between the target user and the subject user, and a set of information maintained in the social networking system associated with the target user. A recommendation generator associated with a maximum value of the utility function is selected and used to generate a recommendation for the target user to establish a connection to a subject user.

### BACKGROUND

This disclosure relates generally to social networking systems, and more specifically to recommending connections to users of a social networking system to maximize a utility function.

A social networking system allows its users to connect and communicate with other social networking system users. Users create profiles in the social networking system that are tied to their identities and include information about the users, such as interests and demographic information. The users may be individuals or entities such as corporations or charities. Because of the popularity of social networking systems and the significant amount of user-specific information maintained in social networking systems, a social networking system provides an ideal forum for allowing users to share content by creating content items for presentation to additional social networking system users. For example, users may share photos or videos they have uploaded by creating content items that include the photos or videos that are presented to additional users to whom they are connected in the social networking system.

Conventionally, social networking systems have various goals. Examples of such goals include increasing the frequency with which their users interact with the social networking systems, increasing the frequency with which their users create content for presentation to other social networking system users, increasing the amount of content created by their users for presentation to other social networking system users, etc. To further these goals, social networking systems often allow their users to “follow” other users of the social networking systems. When users follow each other in social networking systems, connections are established between the users, such that a user who is following another user may receive various types of content maintained in a social networking system that is associated with the user who is being followed. For example, a first user who is following a second user in a social networking system may receive content created by the second user as it is posted to the social networking system by the second user. In this example, the first user may receive the content via a newsfeed associated with a user account of the first user maintained in the social networking system.

To encourage social networking system users to follow each other, social networking systems may send recommendations to their users to follow other users. Social networking systems may generate these recommendations based on information maintained in the social networking systems indicating that the users to whom the recommendations are to be sent are likely to be receptive to the recommendations. For example, suppose that information maintained in a social networking system indicates that a first user and a second user of the social networking system are not following each other in the social networking system and share an interest in photography (e.g., based on user profile information associated with both users). In this example, based on their shared interest in photography, the social networking system may generate a recommendation that is sent to the first user to follow the second user and vice versa.

However, social networking system users may decrease their engagement with social networking systems despite following recommendations to follow other social networking system users. In the above example, if neither the first user nor the second user creates content for presentation to other users of the social networking system, even if the first user and the second user decide to follow each other, neither user may be motivated to create content if they rarely receive new content associated with users they are following. Consequently, in this example, both users may lose interest in the social networking system and decrease the frequency with which they interact with the social networking system. Furthermore, in the above example, additional users of the social networking system who are following the first user and/or the second user also may decrease the frequency with which they interact with the social networking system for the same reason.

### SUMMARY

Conventionally, to further various goals associated with social networking systems, social networking systems often allow their users to follow other users of the social networking systems. Furthermore, to encourage users to follow each other, social networking systems may send recommendations to their users to follow other users. However, social networking system users may decrease their engagement with social networking systems despite following these recommendations to follow other users.

Therefore, to send recommendations to social networking system users (“target users”) to follow other social networking system users (“subject users”) while furthering one or more social networking system goals, a social networking system generates recommendations that maximize one or more utility functions. A value of a utility function indicates a predicted long-term value of a potential connection associated with a recommendation that may be generated by a type of recommendation generator in relation to achievement of a goal of the social networking system. To generate a recommendation for a target user to follow a subject user, the social networking system identifies subject users who the target user is not following. For each type of recommendation generator capable of generating a recommendation for the target user to follow a subject user, the social networking system computes a value of a utility function based at least in part on a set of existing connections between the target user and a set of social networking system users, a potential connection between the target user and the subject user, and a set of information maintained in the social networking system associated with the target user. A recommendation generator associated with a maximum value of the utility function is selected and used to generate a recommendation for the target user to establish a connection to a subject user. The social networking system may then send the recommendation for display to the target user.

In various embodiments, the social networking system also may select a type of recommendation generator to be used for generating a recommendation for the target user to follow a subject user based on a current value of a utility function associated with the target user. In such embodiments, the social networking system may compute a difference between a value of the utility function associated with each type of recommendation generator and the current value of the utility function associated with the target user and select a type of recommendation generator associated with a maximum difference to generate the recommendation. A current value of a utility function associated with the target user may be computed based on information describing existing connections between the target user and other social networking system users and information describing actions performed by the target user and/or the other social networking system users in relation to achievement of a goal of the social networking system.

In some embodiments, the social networking system may rank user accounts associated with the subject users who the target user is not following (e.g., based on a likelihood that the target user will follow each subject user) and assign each user account to one or more types of recommendation generators. In alternative embodiments, the social networking system may assign the user accounts to the recommendation generators and subsequently rank the user accounts assigned to each recommendation generator. Once the social networking system has selected a type of recommendation generator to be used for generating a recommendation for the target user to follow a subject user, the social networking system may select the subject user based on the ranking (e.g., a subject user associated with a user account assigned to the selected recommendation generator having a highest ranking).

### BRIEF DESCRIPTION OF THE DRAWINGS

FIG. 1 is a block diagram of a system environment in which a social networking system operates, in accordance with an embodiment.

FIG. 2 is a block diagram of a social networking system, in accordance with an embodiment.

FIG. 3 is a flow chart of a method for recommending connections to users of a social networking system to maximize a utility function, in accordance with an embodiment.

FIG. 4A is a conceptual diagram of existing and potential connections between a target user and other users of a social networking system, in accordance with an embodiment.

FIG. 4B is an additional conceptual diagram of existing and potential connections between a target user and other users of a social networking system, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

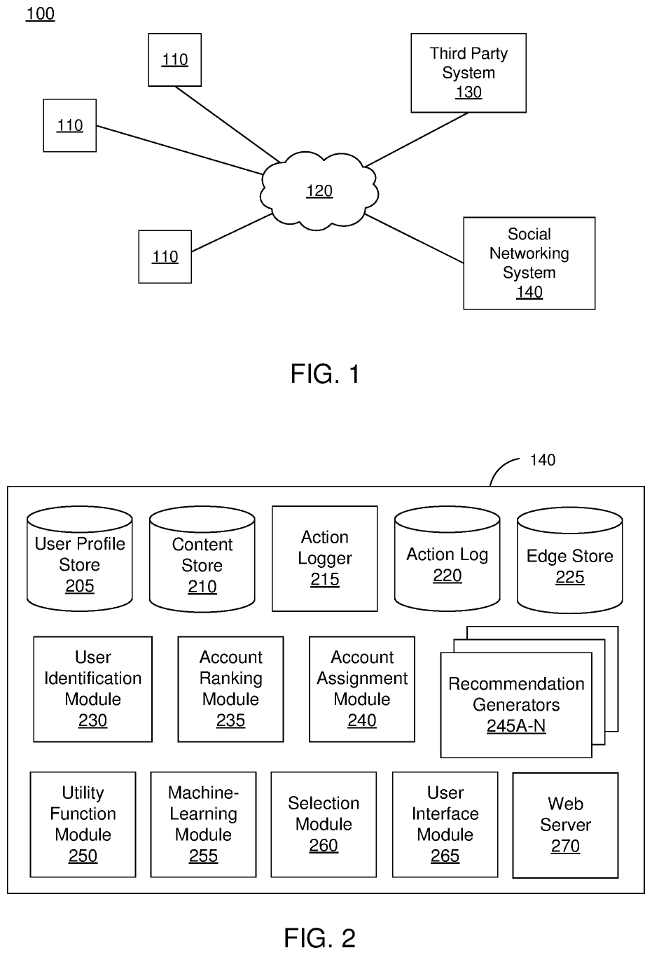

FIG. 1 is a block diagram of a system environment 100 for a social networking system 140. The system environment 100 shown by FIG. 1 comprises one or more client devices 110, a network 120, one or more third-party systems 130, and the social networking system 140. In alternative configurations, different and/or additional components may be included in the system environment 100. The embodiments described herein may be adapted to online systems that are not social networking systems.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the social networking system 140. For example, a client device 110 executes a browser application to enable interaction between the client device 110 and the social networking system 140 via the network 120. In another embodiment, a client device 110 interacts with the social networking system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

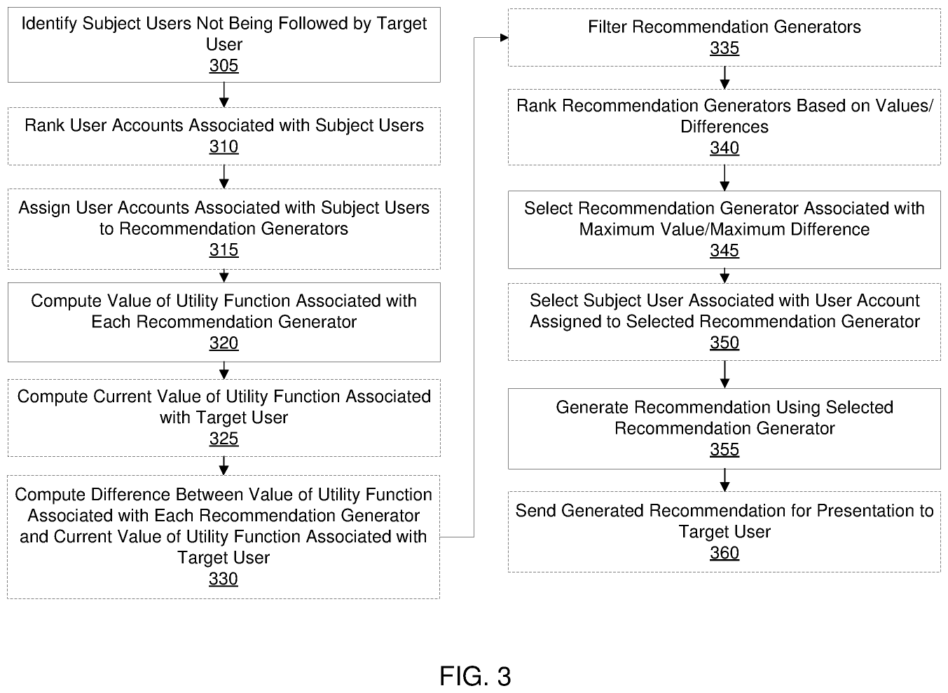

One or more third-party systems 130 may be coupled to the network 120 for communicating with the social networking system 140, which is further described below in conjunction with FIG. 2. In one embodiment, a third-party system 130 is an application provider communicating information describing applications for execution by a client device 110 or communicating data to client devices 110 for use by an application executing on the client device 110. In other embodiments, a third-party system 130 provides content or other information for presentation via a client device 110. A third-party system 130 also may communicate information to the social networking system 140, such as advertisements, content, or information about an application provided by the third-party system 130.

FIG. 2 is a block diagram of an architecture of the social networking system 140. The social networking system 140 shown in FIG. 2 includes a user profile store 205, a content store 210, an action logger 215, an action log 220, an edge store 225, a user identification module 230, an account ranking module 235, an account assignment module 240, multiple recommendation generators 245A-N, a utility function module 250, a machine-learning module 255, a selection module 260, a user interface module 265, and a web server 270. In other embodiments, the social networking system 140 may include additional, fewer, or different components for various applications. Conventional components such as network interfaces, security functions, load balancers, failover servers, management and network operations consoles, and the like are not shown so as to not obscure the details of the system architecture.

Each user of the social networking system 140 is associated with a user profile, which is stored in the user profile store 205. A user profile includes declarative information about the user that was explicitly shared by the user and also may include profile information inferred by the social networking system 140. In one embodiment, a user profile includes multiple data fields, each describing one or more user attributes for the corresponding social networking system user. Examples of information stored in a user profile include biographic, demographic, and other types of descriptive information, such as work experience, educational history, gender, hobbies or preferences, locations and the like. A user profile also may store other information provided by the user, for example, images or videos. In certain embodiments, images of users may be tagged with information identifying the social networking system users displayed in an image. A user profile in the user profile store 205 also may maintain references to actions by the corresponding user performed on content items in the content store 210 and stored in the action log 220.

While user profiles in the user profile store 205 are frequently associated with individuals, allowing individuals to interact with each other via the social networking system 140, user profiles also may be stored for entities such as businesses or organizations. This allows an entity to establish a presence in the social networking system 140 for connecting and exchanging content with other social networking system users. The entity may post information about itself, about its products or provide other information to users of the social networking system 140 using a brand page associated with the entity's user profile. Other users of the social networking system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a page (e.g., a brand page), an advertisement, or any other type of content. Social networking system users may create objects stored by the content store 210, such as status updates, photos tagged by users to be associated with other objects in the social networking system 140, events, groups or applications. In some embodiments, objects are received from third-party applications or third-party applications separate from the social networking system 140. In one embodiment, objects in the content store 210 represent single pieces of content, or content “items.” Hence, social networking system users are encouraged to communicate with each other by posting text and content items of various types of media to the social networking system 140 through various communication channels. This increases the amount of interaction of users with each other and increases the frequency with which users interact within the social networking system 140.

The action logger 215 receives communications about user actions internal to and/or external to the social networking system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the social networking system 140 to track user actions in the social networking system 140, as well as actions in third-party systems 130 that communicate information to the social networking system 140. Users may interact with various objects in the social networking system 140, and information describing these interactions is stored in the action log 220. Examples of interactions with objects include: commenting on posts, sharing links, checking-in to physical locations via a mobile device, accessing content items, and any other suitable interactions. Additional examples of interactions with objects in the social networking system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements in the social networking system 140 as well as with other applications operating in the social networking system 140. In some embodiments, data from the action log 220 is used to infer interests or preferences of a user, augmenting the interests included in the user's user profile and allowing a more complete understanding of user preferences.

The action log 220 also may store user actions taken on a third-party system 130, such as an external website, and communicated to the social networking system 140. For example, an e-commerce website may recognize a user of a social networking system 140 through a social plug-in enabling the e-commerce website to identify the user of the social networking system 140. Because users of the social networking system 140 are uniquely identifiable, e-commerce websites, such as in the preceding example, may communicate information about a user's actions outside of the social networking system 140 to the social networking system 140 for association with the user. Hence, the action log 220 may record information about actions users perform on a third-party system 130, including webpage viewing histories, advertisements that were engaged, purchases made, and other patterns from shopping and buying. Additionally, actions a user performs via an application associated with a third-party system 130 and executing on a client device 110 may be communicated to the action logger 215 for storing in the action log 220 by the application for recordation and association with the user by the social networking system 140.

In one embodiment, the edge store 225 stores information describing connections between users and other objects in the social networking system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 140, such as expressing interest in a page in the social networking system 140, sharing a link with other users of the social networking system 140, and commenting on posts made by other users of the social networking system 140.

In various embodiments, when target users request to follow subject users, connections are established between the target users and the subject users that allow the target users to receive various types of content maintained in the social networking system 140 that is associated with the subject users (e.g., content created by the subject users, content for which the subject users have expressed a preference, etc.). In such embodiments, information describing the connections may be stored in association with edges between the target users and the subject users. For example, upon receiving a request from a target user to follow a subject user, a unidirectional connection is established between the target user and the subject user, in which information stored in association with an edge between the subject user and the target user indicates that the target user is subscribing to content created by the subject user. In this example, based on the information stored in association with the edge, the target user receives content as it is posted to the social networking system 140 by the subject user. Continuing with this example, the target user may receive the content via a user profile page associated with a user account of the target user maintained in the social networking system 140.

In one embodiment, an edge may include various features each representing characteristics of interactions between users, interactions between users and objects, or interactions between objects. For example, features included in an edge describe a rate of interaction between two users, how recently two users have interacted with each other, a rate or amount of information retrieved by one user about an object, or the number and types of comments posted by a user about an object. The features also may represent information describing a particular object or user. For example, a feature may represent the level of interest that a user has in a particular topic, the rate at which the user logs into the social networking system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the social networking system 140 over time to approximate a user's interest in an object or in another user in the social networking system 140 based on the actions performed by the user. A user's affinity may be computed by the social networking system 140 over time to approximate a user's interest in an object, a topic, or another user in the social networking system 140 based on actions performed by the user. Computation of affinity is further described in U.S. patent application Ser. No. 12/978,265, filed on Dec. 23, 2010 (U.S. Publication No. US 2012/0166532 A1, published on Jun. 28, 2012), U.S. patent application Ser. No. 13/690,254 (U.S. Pat. No. 9,070,141, issued on Jun. 30, 2015), filed on Nov. 30, 2012, U.S. patent application Ser. No. 13/689,969, filed on Nov. 30, 2012 (U.S. Pat. No. 9,317,812, issued on Apr. 19, 2016), and U.S. patent application Ser. No. 13/690,088, filed on Nov. 30, 2012 (U.S. Publication No. US 2014/0156360 A1, published on Jun. 5, 2014), each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

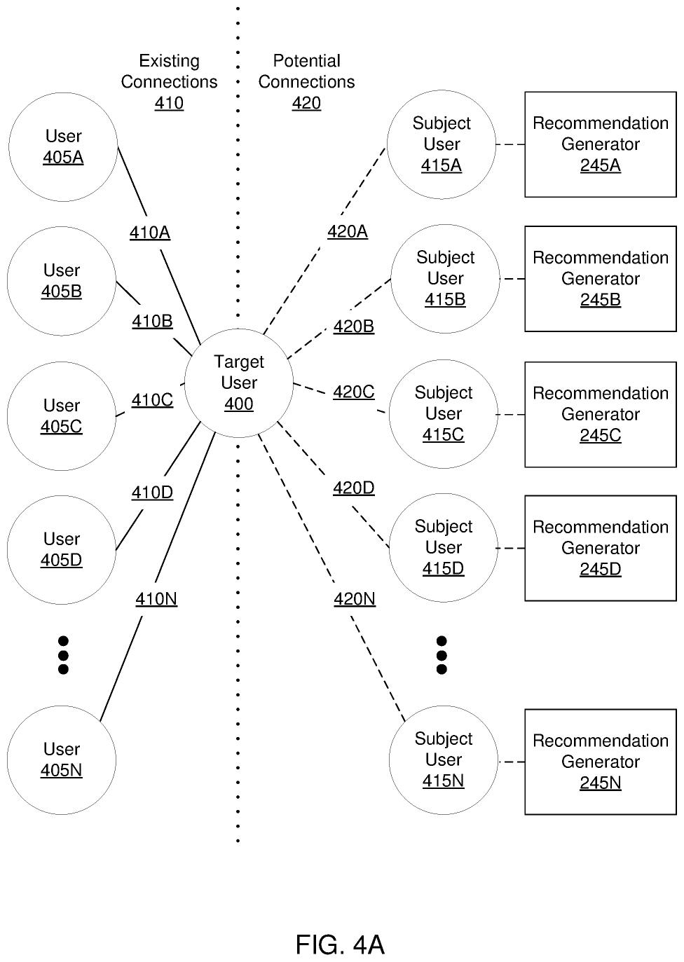

The user identification module 230 identifies (e.g., as shown in step 305 of FIG. 3) subject users who a target user is not currently following in the social networking system 140. In some embodiments, the user identification module 230 may identify the subject users by accessing information stored in the edge store 225. For example, the user identification module 230 may access information stored in the edge store 225 describing existing connections between users of the social networking system 140. In this example, based on the information, the user identification module 230 may identify subject users who a target user is not following. The functionality of the user identification module 230 is further described below in conjunction with FIG. 3.

The account ranking module 235 may rank (e.g., as shown in step 310 of FIG. 3) user accounts associated with subject users identified by the user identification module 230. The account ranking module 235 may rank user accounts associated with subject users based on various types of information. For example, the account ranking module 235 may rank user accounts associated with subject users based on a likelihood that a target user will follow each subject user, based on a frequency with which each subject user has created content for presentation to other social networking system users, based on a frequency with which each subject user interacts with the social networking system 140, and/or based on any other suitable types of information. In some embodiments, the account ranking module 235 may rank the user accounts before the user accounts have been assigned to recommendation generators 245A-N by the account assignment module 240, while in other embodiments, the account ranking module 235 may rank the user accounts after the user accounts have been assigned to the recommendation generators 245A-N by the account assignment module 240, as described below. The functionality of the account ranking module 235 is further described below in conjunction with FIG. 3.

The account assignment module 240 may assign (e.g., as shown in step 315 of FIG. 3) user accounts associated with subject users to whom a target user is not connected to one or more types of recommendation generators 245A-N (described below). For example, if a subject user is a friend or a family member of a target user, the account assignment module 240 may assign a user account associated with the subject user to a type of recommendation generator 245A-N that may generate a recommendation for the target user to follow a subject user who is a friend or a family member of the target user. In this example, if the subject user also shares one or more interests with the target user, the account assignment module 240 also may assign the user account to a type of recommendation generator 245A-N that may generate a recommendation for the target user to follow a subject user who shares an interest with the target user.

In some embodiments, the account assignment module 240 may assign user accounts associated with subject users to whom a target user is not connected to recommendation generators 245A-N once the account ranking module 235 has ranked the user accounts. In such embodiments, when the account assignment module 240 assigns the user accounts to the recommendation generators 245A-N, the user accounts may retain their rankings, such that each user account assigned to a type of recommendation generator 245A-N is associated with a ranking. As described above, in alternative embodiments, the account assignment module 240 may assign user accounts to the recommendation generators 245A-N before the account ranking module 235 ranks the user accounts assigned to each recommendation generator 245A-N. The functionality of the account assignment module 240 is further described below in conjunction with FIG. 3.

The recommendation generators 245A-N generate (e.g., as shown in step 355 of FIG. 3) recommendations that may be sent to target users to follow subject users of the social networking system 140. Different types of recommendations may be sent to target users. Examples of types of recommendations that may be sent to target users include recommendations to follow subject users who are friends or family members of the target users, recommendations to follow subject users who have created at least a threshold amount of content for presentation to other users of the social networking system 140, recommendations to follow subject users who share interests with the target users, recommendations to follow subject users based on a set of business logic, etc. Each recommendation for a target user to follow a subject user may be generated by a type of recommendation generator 245A-N that is capable of generating the type of recommendation. For example, recommendations to follow subject users who are friends or family members of a target user may be generated by one type of recommendation generator 245A-N, while recommendations to follow social networking system users who share interests with the target user may be generated by a different type of recommendation generator 245A-N.

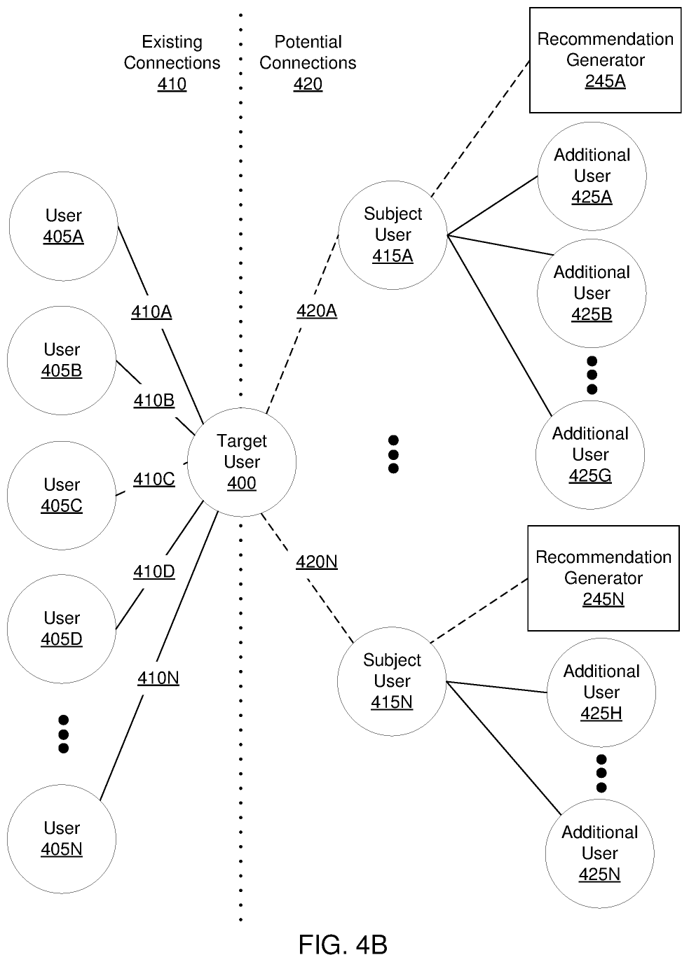

In embodiments in which the account ranking module 235 ranks user accounts associated with subject users, a recommendation generator 245A-N may be used to generate a recommendation for a target user to follow a subject user, in which the subject user is selected (e.g., as shown in step 350 of FIG. 3) by the recommendation generator 245A-N based on the ranking. For example, once the selection module 260 (described below) has selected a type of recommendation generator 245A-N to be used for generating a recommendation for a target user to follow a subject user, the recommendation generator 245A-N may select a subject user associated with a user account assigned to the selected recommendation generator 245A-N having a highest ranking. In this example, the selected recommendation generator 245A-N may then generate a recommendation for the target user to follow the selected subject user. The functionality of the recommendation generators 245A-N is further described below in conjunction with FIGS. 3, 4A, and 4B.

The utility function module 250 computes (e.g., as shown in step 320 of FIG. 3) a value of a utility function associated with each type of recommendation generator 245A-N. A value of a utility function associated with a type of recommendation generator 245A-N indicates a predicted long-term value of a potential connection associated with a recommendation that may be generated by the type of recommendation generator 245A-N in relation to achievement of a goal of the social networking system 140. Examples of goals of the social networking system 140 include encouraging social networking system users to increase the amount of content they create for presentation to other social networking system users, encouraging social networking system users to increase the frequency with which they interact with the social networking system 140, etc.

Potential connections associated with recommendations, if established, may change the way that target users interact with the social networking system 140. For example, if a subject user is a top producer of content that is presented to other users of the social networking system 140, a target user who requests to follow the subject user may be motivated by the subject user to increase the frequency with which they create content for presentation to other social networking system users. As an additional example, if a target user requests to follow a subject user, the target user may increase a frequency with which they use the social networking system 140 in order to view content posted by the subject user. Furthermore, subject users may receive notifications from the social networking system 140 when target users request to follow the subject users, which also may affect the way that the subject users interact with the social networking system 140. In the above example, the new connection to the target user may motivate the subject user to increase the rate at which they produce content for presentation to the target user and to other users of the social networking system 140 to whom the subject user is connected.

A value of a utility function associated with a type of recommendation generator 245A-N may be computed by the utility function module 250 based on information describing how users of the social networking system 140 may change the way they interact with the social networking system 140 if a potential connection associated with a recommendation that may be generated by the type of recommendation generator 245A-N is established. This information may describe existing connections between a target user and other social networking system users and a potential connection that may be established between the target user and a subject user associated with a user account assigned to the type of recommendation generator 245A-N (e.g., a user account having a highest ranking). In various embodiments, this information also may be associated with the target user, the subject user, and/or the other users to whom the target user is currently connected. For example, to compute a value of a utility function associated with a type of recommendation generator 245A-N, the utility function module 250 predicts a probability that a target user will request to follow a subject user associated with a user account assigned to the type of recommendation generator 245A-N. In this example, the utility function module 250 also predicts frequencies with which the target user, the subject user, and/or other users to whom the target user is currently connected will interact with the social networking system 140 if a potential connection is established between the target user and the subject user. Continuing with this example, the utility function module 250 may predict the probability and the frequencies based on various types of information associated with user accounts associated with the users maintained in the social networking system 140 (e.g., demographic information associated with the users, interests and hobbies of the users, actions previously performed by the users in the social networking system 140, etc.). In the above example, the utility function module 250 may compute a value of a utility function associated with the type of recommendation generator 245A-N as a product of the predicted probability and a sum of the predicted frequencies.

In some embodiments, a value of a utility function associated with a type of recommendation generator 245A-N may indicate a predicted long-term value of multiple potential connections that may be established between a target user and other users of the social networking system 140. In the above example, suppose that the subject user is connected to one or more additional users of the social networking system 140 to whom the target user is not connected. In this example, for each of these additional users, the utility function module 250 also may predict a probability that the target user will request to follow the additional user and frequencies with which the target user, the subject user, the users to whom the target user is currently connected, and/or the additional user will interact with the social networking system 140 if a potential connection between the target user and the additional user is established. Continuing with this example, for each additional user, the utility function module 250 may compute a product of the predicted probability and a sum of the predicted frequencies. In this example, the utility function module 250 may compute the value of the utility function associated with the type of recommendation generator 245A-N as a sum of the products (i.e., the product of the predicted probability that the target user will request to follow the subject user and the sum of the predicted frequencies with which the users will interact with the social networking system 140 if the potential connection between the target user and the subject user is established and the product of the predicted probability and the sum of the predicted frequencies computed for each additional user to whom the target user is not connected).

The utility function module 250 also may compute (e.g., as shown in step 325 of FIG. 3) a current value of a utility function associated with a target user. A current value of a utility function associated with a target user may be computed based on information describing existing connections between the target user and other social networking system users and information describing actions performed by the target user and/or the other social networking system users in relation to achievement of a goal of the social networking system 140. For example, the utility function module 250 may compute a current value of a utility function associated with a target user as a sum of the frequencies with which the target user and social networking system users to whom the target user is currently connected create content for presentation to other users of the social networking system 140.

In embodiments in which the utility function module 250 computes a current value of a utility function associated with a target user, the utility function module 250 also may compute (e.g., as shown in step 330 of FIG. 3) a difference between a value of the utility function associated with each type of recommendation generator 245A-N and the current value of the utility function associated with the target user. Continuing with the above example, once the utility function module 250 has computed a value of the utility function associated with each type of recommendation generator 245A-N, the utility function module 250 may subtract the current value of the utility function associated with the target user from the value of the utility function associated with each type of recommendation generator 245A-N to compute a difference between the values.

In some embodiments, the utility function module 250 may compute a value of a utility function associated with each type of recommendation generator 245A-N and/or a difference between the value of the utility function associated with each type of recommendation generator 245A-N and a current value of the utility function associated with a target user using a machine-learning model. In such embodiments, the utility function module 250 may provide various inputs to the model. Examples of inputs to the model include information identifying a target user, information describing existing connections between the target user and additional users of the social networking system 140, information describing a potential connection associated with a recommendation that may be generated by each type of recommendation generator 245A-N, information associated with one or more user accounts maintained in the social networking system 140 (e.g., accounts associated with the target user, users to whom the target user is currently connected, and subject users to whom the target user potentially may be connected), etc. Outputs of the model may include a value of a utility function associated with each type of recommendation generator 245A-N, a difference between the value of the utility function associated with each type of recommendation generator 245A-N and a current value of the utility function associated with a target user, information identifying a type of recommendation generator 245A-N to be used to generate a recommendation for the target user, etc. The functionality of the utility function module 250 is further described below in conjunction with FIGS. 3, 4A, and 4B.

The machine-learning module 255 trains a machine-learning model to compute a value of a utility function associated with a type of recommendation generator 245A-N and/or a difference between the value of the utility function associated with each type of recommendation generator 245A-N and a current value of the utility function associated with a target user. The machine-learning module 255 may train the machine-learning model based on various types of information associated with user accounts associated with social networking system users (e.g., by accessing the user profile store 205) and information describing existing connections between the users (e.g., by accessing the edge store 225). For example, the machine-learning module 255 may train a machine-learning model based on information stored in association with user accounts associated with social networking system users (e.g., age, geographic location, interests, etc.), information describing a time at which the users created their accounts in the social networking system 140, an initial frequency with which the users generated content for presentation to other social networking system users, and an initial frequency with which the users performed various interactions with the social networking system 140. In this example, the machine-learning module 255 also may train the model based on information describing times at which the users established connections to other users in the social networking system 140, information describing the relationships between the connected users, and changes in the frequencies with which the users interacted with the social networking system 140 and/or created content for presentation to other social networking system users following the establishment of each connection. The functionality of the machine-learning module 255 is further described below in conjunction with FIG. 3.

In some embodiments, the selection module 260 may filter (e.g., as shown in step 335 of FIG. 3) for certain types of recommendation generators 245A-N. For example, the selection module 260 may filter 335 for recommendation generators 245A-N that may generate recommendations to follow subject users who are friends or family members of a target user and subject users who share an interest with the target user by including only bid amounts associated with these types of recommendation generators 245A-N in an auction that is used to select a recommendation generator 245A-N to be used for generating a recommendation for the target user. Alternatively, in the above example, the selection module 260 may filter 335 for these types of recommendation generators 245A-N by removing bid amounts associated with other types of recommendation generators 245A-N from the auction.

The selection module 260 also may rank (e.g., as shown in step 340 of FIG. 3) different types of recommendation generators 245A-N based on a value of a utility function associated with each type of recommendation generator 245A-N or based on a difference between the value and a current value of the utility function associated with the target user. For example, the selection module 260 may include a bid amount corresponding to a value of a utility function associated with each type of recommendation generator 245A-N that may be used to generate a recommendation for a target user to follow a subject user in an auction. In this example, the selection module 260 may rank the bid amounts from highest to lowest in the auction.

The selection module 260 selects (e.g., as shown in step 345 of FIG. 3) a type of recommendation generator 245A-N to be used for generating a recommendation for a target user to follow a subject user associated with a user account assigned to the selected recommendation generator 245A-N (e.g., a subject user associated with a user account assigned to the selected recommendation generator 245A-N having a highest ranking). In some embodiments, the selection module 260 may select a type of recommendation generator 245A-N based on a value of a utility function associated with each type of recommendation generator 245A-N. In such embodiments, the selection module 260 may select a type of recommendation generator 245A-N associated with a maximum value of the utility function to generate the recommendation.

In various embodiments, the selection module 260 also may select a type of recommendation generator 245A-N to be used for generating a recommendation for a target user to follow a subject user based on a current value of a utility function associated with the target user. In such embodiments, the utility function module 250 may compute a difference between the value of the utility function associated with each type of recommendation generator 245A-N and the current value of the utility function associated with the target user and the selection module 260 may select a type of recommendation generator 245A-N associated with a maximum difference to generate the recommendation. For example, once the utility function module 250 has computed a difference between a value of a utility function associated with each type of recommendation generator 245A-N and a current value of the utility function associated with a target user, the selection module 260 may determine that the type of recommendation generator 245A-N used to compute a maximum difference should be used to generate a recommendation to be sent to the target user.

In embodiments in which the selection module 260 ranks different types of recommendation generators 245A-N based on a value of a utility function associated with each type of recommendation generator 245A-N or based on a difference between the value and a current value of the utility function associated with a target user, the selection module 260 may select a type of recommendation generator 245A-N based on the ranking. For example, the selection module 260 may select a type of recommendation generator 245A-N associated with a highest ranking (i.e., a maximum value of the utility function) to generate a recommendation for a target user to follow a subject user. The functionality of the selection module 260 is further described below in conjunction with FIG. 3.

The user interface module 265 may generate a user interface including one or more recommendations to be sent to target users of the social networking system 140. In some embodiments, a user interface generated by the user interface module 265 may include one or more recommendations generated by a type of recommendation generator 245A-N selected by the selection module 260. For example, the user interface module 265 may generate a feed of content items (e.g., a newsfeed) that includes a recommendation for a target user to follow a subject user, in which the recommendation is generated by a recommendation generator 245A-N selected by the selection module 260. In this example, the social networking system 140 may send (e.g., as shown in step 360 of FIG. 3) the user interface for presentation in a display area of a mobile device associated with the target user. The functionality of the user interface module 265 is further described below in conjunction with FIG. 3.

The web server 270 links the social networking system 140 via the network 120 to the one or more client devices 110, as well as to the one or more third-party systems 130. The web server 270 serves web pages, as well as other content, such as JAVA®, FLASH®, XML and so forth. The web server 270 may receive and route messages between the social networking system 140 and the client device 110, for example, instant messages, queued messages (e.g., email), text messages, short message service (SMS) messages, or messages sent using any other suitable messaging technique. A user may send a request to the web server 270 to upload information (e.g., images or videos) that are stored in the content store 210. Additionally, the web server 270 may provide application programming interface (API) functionality to send data directly to native client device operating systems, such as IOS®, ANDROID™, WEBOS® or BlackberryOS.

### Recommending Connections to Users of a Social Networking System to Maximize a Utility Function

FIG. 3 is a flow chart of a method for recommending connections to users of a social networking system to maximize a utility function. In other embodiments, the method may include different and/or additional steps than those shown in FIG. 3. Additionally, steps of the method may be performed in a different order than the order described in conjunction with FIG. 3.

The social networking system 140 identifies (in step 305, e.g., using the user identification module 230) subject users who a target user is not currently following in the social networking system 140. In some embodiments, the social networking system 140 may identify 305 the subject users by accessing information stored in the social networking system 140 describing connections between social networking system users (e.g., in the edge store 225). The social networking system 140 may then rank (in step 310, e.g., using the account ranking module 235) user accounts associated with the subject users. The social networking system 140 may rank 310 the user accounts based on various types of information (e.g., based on a likelihood that the target user will follow each subject user, based on a frequency with which each subject user has created content for presentation to other social networking system users, based on a frequency with which each subject user interacts with the social networking system 140, etc.). The social networking system 140 also may assign 315 (e.g., using the account assignment module 240) the user accounts associated with the subject users to whom the target user is not connected to one or more types of recommendation generators 245A-N. In some embodiments, when the social networking system 140 assigns 315 the user accounts to the recommendation generators 245A-N, the user accounts may retain their rankings, such that each user account assigned 315 to a type of recommendation generator 245A-N is associated with a ranking. In alternative embodiments, the social networking system 140 may assign 315 the user accounts to the recommendation generators 245A-N prior to ranking 310 the user accounts assigned 315 to each recommendation generator 245A-N.

The social networking system 140 computes 320 (e.g., using the utility function module 250) a value of a utility function associated with each type of recommendation generator 245A-N. A value of a utility function associated with a type of recommendation generator 245A-N indicates a predicted long-term value of a potential connection associated with a recommendation that may be generated by the type of recommendation generator 245A-N in relation to achievement of a goal of the social networking system 140. Examples of goals of the social networking system 140 include encouraging social networking system users to increase the amount of content they create for presentation to other social networking system users, encouraging social networking system users to increase the frequency with which they interact with the social networking system 140, etc.

A value of a utility function associated with a type of recommendation generator 245A-N may be computed 320 by the social networking system 140 based on various types of information that describe how users of the social networking system 140 may change the way they interact with the social networking system 140 if a potential connection associated with a recommendation that may be generated by the recommendation generator 245A-N is established. This information may describe existing connections between the target user and other social networking system users and a potential connection that may be established between the target user and a subject user associated with a user account assigned 315 to the recommendation generator 245A-N (e.g., a user account assigned 315 to the recommendation generator 245A-N having a highest ranking). In various embodiments, this information also may be associated with the target user, the subject user, and/or the other users to whom the target user is currently connected.

As shown in the example of FIG. 4A, to compute 320 a value of a utility function associated with a type of recommendation generator 245A, the social networking system 140 predicts a probability that a target user 400 will request to follow a subject user 415A associated with a user account assigned 315 to the type of recommendation generator 245A. The social networking system 140 also predicts frequencies with which the target user 400, the subject user 415A, and/or additional users 405A-N having existing connections 410A-N to the target user 400 will interact with the social networking system 140 if a potential connection 420A is established between the target user 400 and the subject user 415A. In this example, the social networking system 140 may predict the probability and the frequencies based on various types of information associated with user accounts associated with the users 400, 405A-N, 415A maintained in the social networking system 140 (e.g., demographic information associated with the users 400, 405A-N, 415A, interests and hobbies of the users 400, 405A-N, 415A, actions previously performed by the users 400, 405A-N, 415A in the social networking system 140, etc.). Continuing with this example, the social networking system 140 may compute 320 a value of a utility function associated with the type of recommendation generator 245A as a product of the predicted probability and a sum of the predicted frequencies. In the above example, the social networking system 140 may compute 320 a value of the utility function associated with the other types of recommendation generators 245B-N in a similar manner.

In some embodiments, a value of a utility function associated with a type of recommendation generator 245A-N may indicate a predicted long-term value of multiple potential connections that may be established between a target user and other users of the social networking system 140. In the above example, suppose that the subject user 415A is connected to one or more additional users 425A-G of the social networking system 140 to whom the target user 400 is not connected, as shown in FIG. 4B. In this example, for each of these additional users 425A-G, the social networking system 140 also may predict a probability that the target user 400 will request to follow the additional user 425A-G and frequencies with which the target user 400, the subject user 415A, the users 405A-N having existing connections 410A-N to the target user 400, and/or the additional user 425A-G will interact with the social networking system 140 if a potential connection between the target user 400 and the additional user 425A-G is established. Continuing with this example, for each additional user 425A-G, the social networking system 140 may compute 320 a product of the predicted probability and a sum of the predicted frequencies. In this example, the social networking system 140 may compute 320 the value of the utility function associated with the type of recommendation generator 245A as a sum of the products (i.e., the product of the predicted probability that the target user 400 will request to follow the subject user 415A and the sum of the predicted frequencies with which the users 400, 415A, 405A-N will interact with the social networking system 140 if the potential connection between the target user 400 and the subject user 415A is established and the product of the predicted probability and the sum of the predicted frequencies computed for each additional user 425A-G to whom the target user 400 is not connected). In the above example, the social networking system 140 may compute 320 a value of the utility function associated with the other types of recommendation generators 245B-N in a similar manner.

Referring back to FIG. 3, the social networking system 140 also may compute 325 (e.g., using the utility function module 250) a current value of a utility function associated with the target user. A current value of a utility function associated with the target user may be computed 325 based on information describing existing connections between the target user and other social networking system users and information describing actions performed by the target user and/or the other social networking system users in relation to achievement of a goal of the social networking system 140. In embodiments in which the social networking system 140 computes 325 a current value of a utility function associated with the target user, the social networking system 140 also may compute 330 (e.g., using the utility function module 250) a difference between a value of the utility function associated with each type of recommendation generator 245A-N and the current value of the utility function associated with the target user.

In some embodiments, the social networking system 140 may compute 320 a value of a utility function associated with each type of recommendation generator 245A-N and/or compute 330 a difference between the value of the utility function associated with each type of recommendation generator 245A-N and a current value of the utility function associated with the target user using a machine-learning model. In such embodiments, the social networking system 140 may train the model (e.g., using the machine-learning module 255). Furthermore, in such embodiments, the social networking system 140 may provide various inputs to the model. Examples of inputs to the model include information identifying the target user, information describing existing connections between the target user and additional users of the social networking system 140, information describing a potential connection associated with a recommendation that may be generated by each type of recommendation generator 245A-N, information associated with one or more user accounts maintained in the social networking system 140 (e.g., accounts associated with the target user, users to whom the target user is currently connected, and subject users to whom the target user potentially may be connected), etc. Outputs of the model may include a value of a utility function associated with each type of recommendation generator 245A-N, a difference between the value of the utility function associated with each type of recommendation generator 245A-N and a current value of the utility function associated with the target user, information identifying a type of recommendation generator 245A-N to be used to generate a recommendation for the target user, etc.

The social networking system 140 may filter 335 (e.g., using the selection module 260) for certain types of recommendation generators 245A-N (e.g., by including only bid amounts associated with these types of recommendation generators 245A-N in an auction that is used to select a recommendation generator 245A-N that is used to generate a recommendation for the target user). The social networking system 140 also may rank (in step 340, e.g., using the selection module 260) different types of recommendation generators 245A-N based on the value of the utility function associated with each type of recommendation generator 245A-N or based on a difference between the value and the current value of the utility function associated with the target user.

The social networking system 140 selects 345 (e.g., using the selection module 260) a type of recommendation generator 245A-N to be used to generate a recommendation for the target user to follow a subject user associated with a user account assigned 315 to the selected recommendation generator 245A-N (e.g., a subject user associated with a user account assigned 315 to the selected recommendation generator 245A-N having a highest ranking). In some embodiments, the social networking system 140 may select 345 a type of recommendation generator 245A-N based on a value of a utility function associated with each type of recommendation generator 245A-N. In such embodiments, the social networking system 140 may select 345 a type of recommendation generator 245A-N associated with a maximum value of the utility function to generate the recommendation. In various embodiments, the social networking system 140 also may select 345 a type of recommendation generator 245A-N to be used for generating a recommendation for the target user to follow a subject user based on a current value of a utility function associated with the target user (e.g., based on the difference between the value of the utility function associated with each type of recommendation generator 245A-N and the current value of the utility function associated with the target user). In embodiments in which the social networking system 140 ranks (in step 340) different types of recommendation generators 245A-N based on a value of a utility function associated with each type of recommendation generator 245A-N or based on a difference between the value and a current value of the utility function associated with the target user, the social networking system 140 may select 345 a type of recommendation generator 245A-N based on the ranking.

In embodiments in which the social networking system 140 ranks (in step 310) user accounts associated with subject users, the subject user may be selected 350 (e.g., using the recommendation generator 245A-N selected 345 by the social networking system 140) based on the ranking. For example, once the social networking system 140 has selected 345 a type of recommendation generator 245A-N to be used for generating a recommendation for a target user to follow a subject user, the social networking system 140 may select 350 a subject user associated with a user account assigned 315 to the selected recommendation generator 245A-N having a highest ranking. The social networking system 140 generates 355 a recommendation for the target user to follow a subject user using the recommendation generator 245A-N selected 345 by the social networking system 140. In the above example, the selected recommendation generator 245A-N may generate 355 a recommendation for the target user to follow the selected subject user.

The social networking system 140 may then send 360 the recommendation for display to the target user. In some embodiments, the recommendation may be included in a user interface (e.g., generated by the user interface module 265). In such embodiments, the user interface may include one or more recommendations generated 355 by the type of recommendation generator 245A-N selected 345 by the social networking system 140. For example, the social networking system 140 may generate a feed of content items (e.g., a newsfeed) that includes a recommendation for a target user to follow a subject user generated 355 by a recommendation generator 245A-N selected 345 by the social networking system 140. In this example, the social networking system 140 may send 360 the user interface for presentation in a display area of a mobile device associated with the target user.

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

1. A method comprising:
maintaining a plurality of connections by a social networking system, each connection comprising a connection established between two or more of a plurality of users of the social networking system;
selecting one or more subject users of the plurality of users of the social networking system to whom a target user of the plurality of users of the social networking system is not connected to;
maintaining a plurality of recommendation generators, wherein each recommendation generator is associated with a respective type of subject user for the target user and is configured to generate a distinct type of recommendation to the target user to follow a subject user of the respective type;
assigning, to each recommendation generator, a respective group of subject users from the one or more subject users the target user is not connected to based on the types of the plurality of recommendation generators;
for each recommendation generator of the plurality of recommendation generators:
computing a current value of a utility function based at least in part on the existing maintained connections between the target user and a set of users of the social networking system,
computing a potential value of the utility function based at least in part on a potential connection between the target user and a subject user assigned to the recommendation generator, the potential value a combination of a likelihood that the target user will establish the potential connection with the subject user in response to a recommendation from the recommendation generator, and predicted frequencies with which the target user and the subject user will interact with the social networking system if the potential connection is established, the potential value of the utility function determined using a machine learning model; and
computing a value of the utility function based on a difference between the potential value and the current value,
selecting a recommendation generator from the plurality of recommendation generators based on the computed values of the utility function for each of the recommendation generators;
selecting a subject user from the selected recommendation generator; and
generating a recommendation to establish the connection to the selected subject user using the selected recommendation generator.

2. The method of claim 1, further comprising:
sending the recommendation for display to the target user.

3. The method of claim 1, wherein the distinct type of recommendation to the target user to follow a subject user of the respective type is selected from a group consisting of: a recommendation to establish a connection to a subject user corresponding to a friend of the target user, a recommendation to establish a connection to a subject user corresponding to a family member of the target user, a recommendation to establish a connection to a subject user who shares an interest with the target user, a recommendation to establish a connection to a subject user who has generated at least a threshold amount of content for presentation to users of the social networking system, and a recommendation to establish a connection to a subject user based on a set of business logic.

4. The method of claim 1, further comprising:
ranking a plurality of user accounts maintained in the social networking system associated with the one or more subject users the target user is not connected to;
selecting the subject user associated with a user account assigned to the selected recommendation generator based at least in part on the ranking.

5. The method of claim 4, wherein the ranking is based at least in part on one or more selected from the group consisting of: a likelihood that the target user will follow each of the one or more subject users, a frequency with which each of the one or more subject users creates content for presentation to other social networking system users, and a frequency with which each of the one or more subject users interacts with the social networking system.

6. The method of claim 1, wherein the value of the utility function associated with a goal of the social networking system is further based at least in part on an additional set of information maintained in the social networking system associated with one or more of: the set of users and the subject user.

7. (canceled)

8. The method of claim 1,
wherein the selected recommendation generator is associated with a maximum difference between the potential value of the utility function associated with each of the plurality of recommendation generators and the current value of the utility function associated with the target user.

9. The method of claim 6, wherein the goal is selected from the group consisting of: increasing a frequency with which users of the social networking system create content for presentation to other social networking system users and increasing a frequency with which users of the social networking system interact with the social networking system.

10. The method of claim 1, wherein the value of the utility function associated with a goal of the social networking system is further based at least in part on one or more additional potential connections between the target user and one or more additional users of the social networking system to whom the subject user is connected in the social networking system.

11. The method of claim 1, wherein computing the value of the utility function associated with a goal of the social networking system comprises:
predicting a probability that the target user will request to establish the connection to the subject user.

12. A computer program product comprising a non-transitory computer readable storage medium having instructions encoded thereon that, when executed by a processor, cause the processor to:
maintain a plurality of connections by a social networking system, each connection comprising a connection established between two or more of a plurality of users of the social networking system;
select one or more subject users of the plurality of users of the social networking system to whom a target user of the plurality of users of the social networking system is not connected to;
maintain a plurality of recommendation generators, wherein each recommendation generator is associated with a respective type of subject user for the target user and is configured to generate a distinct type of recommendation to the target user to follow a subject user of the respective type;
assigning, to each recommendation generator, a respective group of subject users from the one or more subject users the target user is not connected to based on the types of the plurality of recommendation generators;
for each recommendation generator of the plurality of recommendation generators:
compute a current value of a utility function based at least in part on the existing maintained connections between the target user and a set of users of the social networking system,
compute a potential value of the utility function based at least in part on a potential connection between the target user and a subject user assigned to the recommendation generator, the potential value a combination of a likelihood that the target user will establish the potential connection with the subject user in response to a recommendation from the recommendation generator, and predicted frequencies with which the target user and the subject user will interact with the social networking system if the potential connection is established, the potential value of the utility function determined using a machine learning model; and
compute a value of the utility function based on a difference between the potential value and the current value,
select a recommendation generator from the plurality of recommendation generators based on the computed values of the utility function for each of the recommendation generators;
selecting a subject user from the selected recommendation generator; and
generate a recommendation to establish the connection to the selected subject user using the selected recommendation generator.

13. The computer program product of claim 12, wherein the computer readable storage medium further has instructions encoded thereon that, when executed by the processor, cause the processor to:
send the recommendation for display to the target user.

14. The computer program product of claim 12, wherein the distinct type of recommendation to the target user to follow a subject user of the respective type is selected from a group consisting of: a recommendation to establish a connection to a subject user corresponding to a friend of the target user, a recommendation to establish a connection to a subject user corresponding to a family member of the target user, a recommendation to establish a connection to a subject user who shares an interest with the target user, a recommendation to establish a connection to a subject user who has generated at least a threshold amount of content for presentation to users of the social networking system, and a recommendation to establish a connection to a subject user based on a set of business logic.

15. The computer program product of claim 12, wherein the computer readable storage medium further has instructions encoded thereon that, when executed by the processor, cause the processor to:
rank a plurality of user accounts maintained in the social networking system associated with the one or more subject users the target user is not connected to;
select the subject user associated with a user account assigned to the selected recommendation generator based at least in part on the ranking.

16. The computer program product of claim 15, wherein the rank is based at least in part on one or more selected from the group consisting of: a likelihood that the target user will follow each of the one or more subject users, a frequency with which each of the one or more subject users creates content for presentation to other social networking system users, and a frequency with which each of the one or more subject users interacts with the social networking system.

17. The computer program product of claim 12, wherein the value of the utility function associated with a goal of the social networking system is further based at least in part on an additional set of information maintained in the social networking system associated with one or more of: the set of users and the subject user.

18. (canceled)

19. The computer program product of claim 12,
wherein the selected recommendation generator is associated with a maximum difference between the potential value of the utility function associated with each of the plurality of recommendation generators and the current value of the utility function associated with the target user.

20. The computer program product of claim 17, wherein the goal is selected from the group consisting of: increasing a frequency with which users of the social networking system create content for presentation to other social networking system users and increasing a frequency with which users of the social networking system interact with the social networking system.

21. The computer program product of claim 12, wherein the value of the utility function associated with a goal of the social networking system is further based at least in part on one or more additional potential connections between the target user and one or more additional users of the social networking system to whom the subject user is connected in the social networking system.

22. The computer program product of claim 12, wherein compute the value of the utility function associated with a goal of the social networking system comprises:
predict a probability that the target user will request to establish the connection to the subject user.

23. (canceled)

24. (canceled)

25. (canceled)
